(19) United States
(12) Patent Application Publication
(10) Pub. No.: US 2018/0144298 A1
(43) Pub. Date: May 24, 2018

(54) TRACKING SHIPPING USING BLOCKCHAIN

(71) Applicant: Carneros Bay Capital, LLC, San Francisco, CA (US)

(72) Inventor: Brian RANKIN, San Rafael, CA (US)

(21) Appl. No.: 15/818,611

(22) Filed: Nov. 20, 2017

Related U.S. Application Data
(60) Provisional application No. 62/424,787, filed on Nov. 21, 2016.

(51) Int. Cl. G06Q 10/08; H04L 9/34

(52) U.S. Cl. CPC G06Q 10/0833; H04L 9/34

(57) ABSTRACT

In one embodiment, a secure tracking method and apparatus for cargo in a physical commodity (a container for physical goods) is provided. A wireless ID communicator is provided in each container. A receiver on a transporter (a ship, truck, airplane, or drone) receives periodic goods status updates from a plurality of wireless ID communicators in containers on the transporter. The status updates are transmitted to a central blockchain maintained in a central blockchain database remote from the transporter. The status updates are also added to a local sidechain of the blockchain maintained in a side chain database on the transporter.

### CROSS-REFERENCES TO RELATED APPLICATIONS

This application claims the benefit of U.S. Provisional Patent Application No. 62/424,787 filed Nov. 21, 2016, entitled “Tracking Shipping Using Blockchain”, the disclosure of which is hereby incorporated herein by reference in its entirety.

### BACKGROUND OF THE INVENTION

Containers of many different types, shapes, and sizes exist for a myriad of purposes for both food and non-food items. Modern shipping logistics uses a physical commodity, such as intermodal containers, boxes, crates, barrels, pallets and other shipping containers, that are a means to bundle cargo and material goods into larger, unitized loads, that can be easily handled, moved, and stacked, and that will pack tightly in a ship or yard. The challenges of monitoring the condition of the goods within each shipping receptacle, such as goods that require refrigeration, valuables that can be the target of break-ins and burglary, and dangerous or illegal materials that can be used nefariously, can result in lower throughput, an ever-increasing backlog of unfinished tasks, delayed financial settlements, and, in general, delivery postponements and lack of confidence in material status. It is desirable to have improved processes and apparatus for tracking shipped goods and monitoring their condition.

### BRIEF SUMMARY OF THE INVENTION

In one embodiment, a secure tracking method and apparatus for cargo in a physical commodity (a container for physical goods) is provided. A wireless ID communicator is provided in each container. A receiver on a transporter (a ship, truck, airplane, or drone) receives periodic goods status updates from a plurality of wireless ID communicators in containers on the transporter. The status updates are transmitted to a central blockchain database remote from the transporter. The status updates are also added to a local sidechain (a private permissioned blockchain) maintained on the transporter.

In one embodiment, the wireless ID communicator (e.g., RFID tag) receives updates from one or more sensors in a container. The sensors in various embodiments are sensing radioactive elements, chemical explosives, or various type of electromagnetic transmissions to ensure that containers aren't being used nefariously; and more commonly to ensure that goods are not being tampered with. In some embodiments the wireless ID communicators sense the internal temperature of containers and update the sidechain if temperatures vary, or sense the physical integrity of the container, or periodically inventory the contents of the container.

In one embodiment, multiple layers of security are provided using a blockchain. A unique public/private key for each group of containers is provided. A unique hash for each container is provided. Updates to container status are tracked in a cryptographically secure method in a sidechain (a private permissioned blockchain). Updates to the central blockchain are secured via consensus with sidechain nodes on the transporters.

### BRIEF DESCRIPTION OF THE DRAWINGS

FIG. 1 is a diagram of a shipping tracking path according to an embodiment of the invention.

FIG. 2 is a diagram of a shipping tracking hardware system according to an embodiment of the invention.

FIG. 3 is a diagram of a computer system according to an embodiment of the invention.

### DETAILED DESCRIPTION OF THE INVENTION

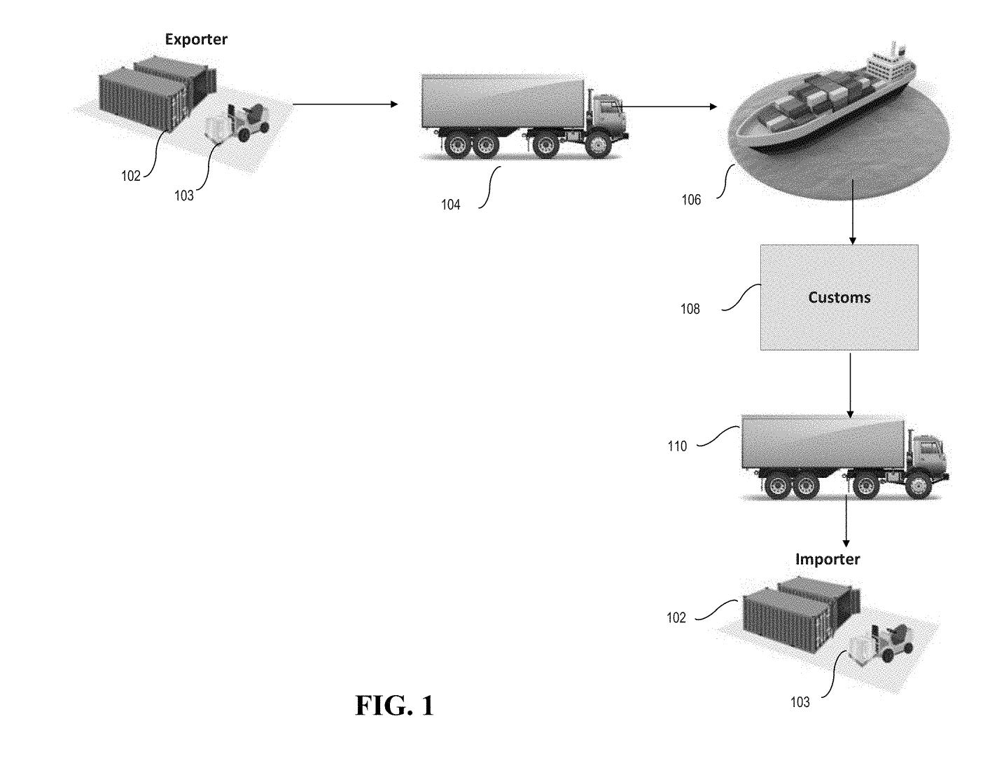

FIG. 1 is a diagram of a shipping tracking path according to an embodiment of the invention. Goods are tracked through the path shown in FIG. 1. Goods are first loaded into a container 102 at an exporter. The goods may all belong to the same vendor, or it may be a consolidated container with goods from multiple vendors. The goods can be tracked by tracking the container 102, a pallet 103, or any other grouping within container 102.

Container 102 is loaded onto a truck 104 and is subsequently loaded onto a container ship 106. When the container 102 is offloaded from container ship 106, it may pass through customs 108. The container is then loaded onto another truck 110 and transported to a buyer, importer 112. Importer 112 then unloads the container, including pallet 103.

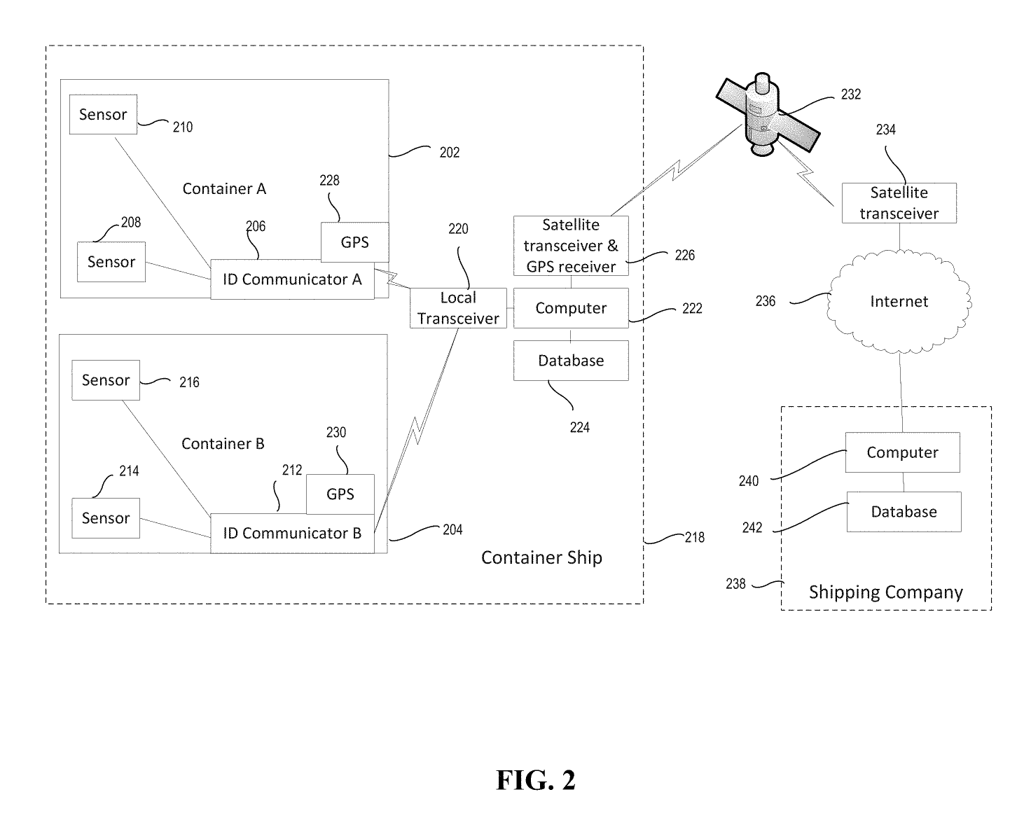

FIG. 2 is a diagram of a shipping tracking hardware system according to an embodiment of the invention. In order to track container 102 of FIG. 1, an ID communicator is provided in each container 102. FIG. 2 illustrates an ID communicator 206 in a container 202, and another ID communicator 212 in container 204. Alternately, an ID communicator can be provided on each pallet, or at least on pallets belonging to different vendors in a consolidated container. In one embodiment, an ID communicator on a pallet is a simple RFID tag which is read by the ID communicator to record which pallets are in the container.

In one embodiment, container 202 includes multiple sensors, such as sensors 208 and 210. The sensors in one embodiment include one or more of sensors for sensing radioactive elements, chemical explosives, or various type of electromagnetic transmissions to ensure that containers aren't being used nefariously, and more commonly to ensure that inventory isn't being tampered with in any way. Alternately, sensors sense the internal temperature of containers, the physical integrity of the container, or periodically inventory the contents of the container, etc. In one embodiment, each container also contains a GPS receiver 228, 230, which provides location information to ID communicators 206, 212. In one embodiment, the ID communicators are RFID tags.

Containers A (202) and B (204) are two of multiple containers loaded on a container ship 218. Container ship 218 has a local transceiver 220 for communicating with the ID communicators 206, 212. The communications may be one-way from the ID communicators to the transceiver, or two-way. For one-way communications, the transceiver may be replaced with a receiver. Transceiver 220 provides the received data to a computer 222, which stores the data in a local database 224.

The data is secured by using a local private permissioned blockchain instance (a sidechain), which is stored in database 224. This is unique to each ship. Each ID communicator has a private and public key used for encrypting the data it provides to computer 222 for updating the sidechain in database 224. Thus, every update of position, temperature, etc. from the ID communicator is added to the sidechain to provide a secure, detailed status of the journey and conditions during the journey for the goods in the container.

A transceiver 226 communicates with a satellite 232, and may include a GPS receiver. Alternately, the GPS receivers in the containers could be used instead, without a GPS receiver associated with transceiver 226. In other embodiments, a separate GPS receiver could be used, or a GPS receiver associated with the container ship could be used instead of the GPS receivers 228 and 230 in the containers.

The transceiver provides a copy of the current sidechain to satellite 232, which then communicates with a satellite transceiver 234. Satellite transceiver 234 communicates through the Internet 236 with a computer 240 at a shipping company facility 238. The sidechain received is used to update a blockchain in database 242.

In one embodiment, the computer 222, database 224, and transceivers 220 and 226 are mounted in the container trucks 104 and 110 of FIG. 1. In alternate embodiments, the system can be used on other transporters in the shipping chain, such as an airplane or a drone. In this way, complete end-to-end tracking is provided. The sidechain may be handed off to the container ship computer when the container is loaded. Thus, multiple sidechains from multiple trucks can be combined into a larger sidechain for the container ship. Similar computer systems and sidechains may be provided at docking facilities, where containers are stored while awaiting loading onto a ship, or after being off-loaded and waiting to be loaded on a truck. Thus, the conditions of the goods while sitting in the facility can be tracked. With busy ports, worker strikes, etc., containers can spend a substantial amount of time at a dock. A similar system can be provided at a customs office, with the sidechain being updated to reflect any opening of the container and inspection of the goods.

Tracking data is made extremely secure with multiple layers of security:
Unique public/private key for each group of containers
Unique hash for each container.
Updates to container status are tracked in a cryptographically secure method in a sidechain
Updates to the central blockchain are secured via consensus with the sidechain nodes on the ships.

Because of the security & granularity of the blockchain updates, the central blockchain can be used to confirm delivery, physical security checks, etc., all along the shipping chain. The blockchain could be used to confirm these events to trigger automatic transfer of payments according to a smart contract.

In one embodiment, on each container ship there are the following:
A local copy of a private permissioned blockchain instance (a sidechain). This is unique to each ship.
Cluster of public & private keys for each vendor shipping containers. For example: if a container ship has 100 vendors each shipping 500 containers (for a total of 50,000 containers) there are 100 pairs of public/private keys managing the 50,000 containers.
An RFID interrogator
RFID tags on each shipping container
A reliable 24×7 satellite connection to a centralized receiver at the shipping company

In one embodiment, the following chain of events occur during the shipment process:
1. A group of containers for a vendor are loaded onto a ship.
2. A public/private key pair is assigned to the group of containers. The public key is componentized into macro-components. This is done per the following example:

1 The Public key is generated: 1BmyuY3iwsaW1KTop3gbyWHA1sH6sEfGDc. The corresponding private key is stored in the sidechain.
Add a suffix to the public key that is a container number. For container #3 add 003, thus: 1BmyuY3iwsaW1KTop3gbyWHA1sH6sEfGDc003
Create a SHA-256 hash from the container's public key: e68c86e45da3d84f9d9fb71cc4614d44c93ceb35428ff4b8d4eae84aa4cf9e7c. Note that this hash is NOT stored in the sidechain as this would compromise security.
3. An RFID tag is attached to each container as it is loaded. The RFID tag communicates with the sidechain instance and requests a key component. In this example, the hash e68c86e45da3d84f9d9fb71cc4614d44c93ceb35428ff4b8d4eae84aa4cf9e7c is calculated and transmitted from the RFID interrogator into the RFID Tag of container #3.
4. The RFID tag periodically accesses the sidechain to update the status of the container. For every access:
   The RFID tag passes the hash e68c86e45da3d84f9d9fb71cc4614d44c93ceb35428ff4b8d4eae84aa4cf9e7c to the sidechain
   The sidechain uses the public key 1BmyuY3iwsaW1KTop3gbyWHA1sH6sEfGDc, adds a number and hashes it to calculate a matching hash. The formula is [hash+(n+1)]. Examples:
      1BmyuY3iwsaW1KTop3gbyWHA1sH6sEfGDc001
      1BmyuY3iwsaW1KTop3gbyWHA1sH6sEfGDc002
      1BmyuY3iwsaW1KTop3gbyWHA1sH6sEfGDc003 etc.

Once the hash calculated matches the hash transmitted by the RFID tag, (in this example 1BmyuY3iwsaW1KTop3gbyWHA1sH6sEfGDc003 matches hash e68c86e45da3d84f9d9fb71cc4614d44c93ceb35428ff4b8d4eae84aa4cf9e7c) the sidechain is updated with the status of the container.

For each container: Each update in the sidechain is cryptographically connected to the previous update (the core concept of the blockchain). This ensures that all of the updates are secure because a false update can't be inserted into the chain of transactions in the sidechain.

The sidechain for each container is updating a central blockchain for the shipping agency via satellite transmission (secured over https). As the updates to the central blockchain occur, all sidechain nodes need to agree via consensus that the latest block is valid, and in so doing the central blockchain is updated. If a bad actor tries to insert invalid data into the central blockchain, the sidechain nodes will catch this and invalidate the malicious entry.

In one embodiment, transactions are executed directly on a Trade Finance platform itself through the use of smart contracts embedded in the platform that is connected to payment systems and distribution networks for smoother flow of payments, goods and services, disintermediating untrusted third parties and allowing, in near-real time,
1. The location of goods to be monitored
2. Settlement of financial transactions when the product has reached its destination, or has passed various checkpoints along the way
3. Reduce or eliminate fraud around manual paperwork

Example for a single container of consumer electronics) being shipped from Port San Pedro, Los Angeles, to Jeddah, Saudi Arabia.
Consumer electronics are loaded into a container. This is entered into the blockchain with a unique ID which is used throughout the shipment process.
Shipping agency in Port San Pedro enters a smart contract on a distributed ledger (blockchain), specifying all of the steps involved in the shipment (loading, inspections, transfers, etc.) as well as the bill-of-lading
As the container ship is in-transit, the ship updates the blockchain with the GPS location of the ship. These updates provided a validated history of travel and can be queried at any time to find the location of the container.
A security sensor inside the container updates the blockchain with the physical condition of the product(s) within the container, validating that the container is maintaining its integrity. This allows product insurers as well as the recipient to obtain real time data on the integrity of the product.
If the container is handed-off to another intermediate shipping agency, this is recorded on the blockchain.
All inspections & clearances are recorded on the blockchain.
Once the container reaches the destination port in Jeddah: the receiving shipping agency records the receipt of the container on the blockchain. If all items in the smart contract have been completed, and the container has maintained its physical integrity, the smart contract is executed, allowing payment for the shipping of this container (and payment to any other agencies involved in the shipment of this container).

All participants in this shipment enter cryptographically signed transactions on the blockchain. Because all participants are seeing, in real-time, blockchain updates as they occur, and because false updates cannot be inserted without breaking the chain, settlements can occur immediately and with confidence that the product has reached its destination with full integrity. The process can be initiated when two or more parties (e.g., exporter and importer) apply digital signatures to initiate the blockchain. The satisfaction of the delivery in good condition and the release of funds is then done automatically without further input from the parties.

### Computer Diagram

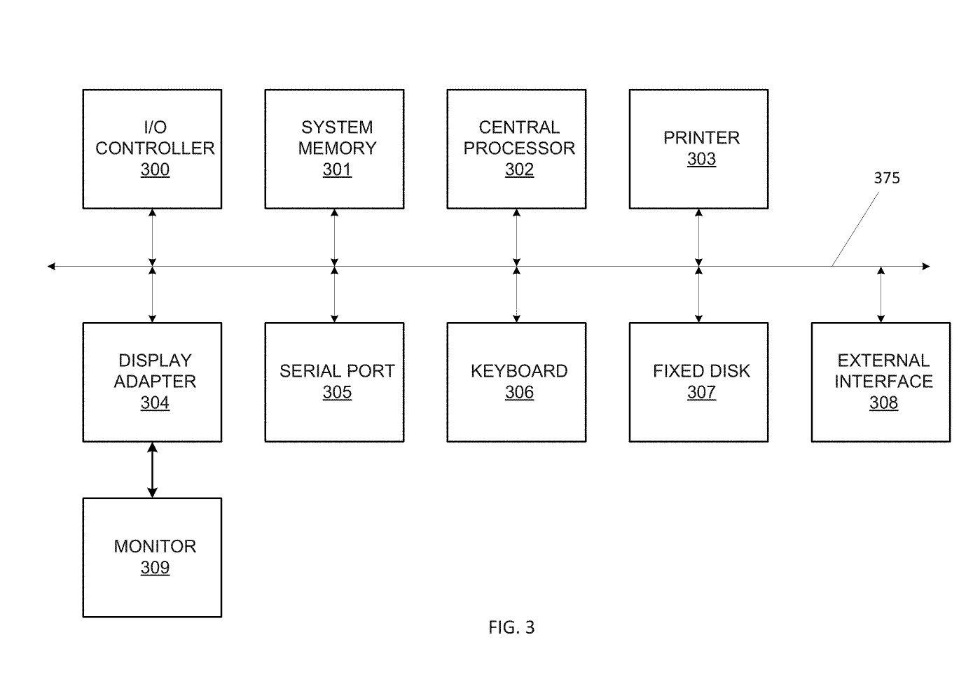

FIG. 3 is a high level block diagram of a computer system that may be used to implement any of the entities or components described above, such as computers 222 and 240. The subsystems shown in FIG. 3 are interconnected via a system bus 375. Additional subsystems include a printer 303, keyboard 306, fixed disk 307, and monitor 309, which is coupled to display adapter 304. Peripherals and input/output (I/O) devices, which couple to I/O controller 300, can be connected to the computer system by any number of means known in the art, such as a serial port. For example, serial port 305 or external interface 308 can be used to connect the computer apparatus to a wide area network such as the Internet, a mouse input device, or a scanner. The interconnection via system bus 375 allows the central processor 302 to communicate with each subsystem and to control the execution of instructions from system memory 301 or the fixed disk 307, as well as the exchange of information between subsystems. The system memory 301 and/or the fixed disk may embody a computer-readable non-transitory medium.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

The communications described herein can be over the Internet, mobile phone data network, a satellite link, or any other communication link. The linking between exporter and importer can be through a website with API access to each party, or any other communication method. The parties can sign appropriate documents using electronic signatures or a document signing service such as provided by Docusign.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

The foregoing discussion discloses and describes exemplary embodiments of tracking a physical commodity (a container for physical goods). The containers and transporters may be embodied in other specific forms without departing from the spirit or essential characteristics thereof. Accordingly, the discussion is intended to be illustrative, but not limiting of the scope of the embodiments, as well as the claims.

What is claimed is:

1. A secure tracking system comprising:
a plurality of wireless ID communicators mounted in a physical commodity (a container for physical goods);
a transporter receiver mounted on a transporter and configured to receive periodic status updates from the plurality of wireless ID communicators in containers on the transporter;
a processor coupled to the transporter receiver for adding the status updates to a central blockchain and a sidechain;
a database coupled to the processor for storing the sidechain;
a transporter transmitter for transmitting an updated blockchain to a central blockchain database remote from the transporter.

2. The secure tracking system of claim 1 wherein the transporter is one of a truck, a ship, an airplane and a drone.
